(19) United States
(12) Patent Application Publication
(10) Pub. No.: US 2022/0210999 A1
(43) Pub. Date: Jul. 7, 2022

(54) FEEDING SYSTEM FOR AN ANIMAL

(71) Applicant: RICHARD ROSS, FORT LAUDERDALE, FL (US)

(72) Inventor: RICHARD ROSS, FORT LAUDERDALE, FL (US)

(21) Appl. No.: 17/141,362

(22) Filed: Jan. 5, 2021

(51) Int. Cl. A01K 5/01; A01K 7/00

(52) U.S. Cl. CPC A01K 5/0128; A01K 7/00

(57) ABSTRACT

A feeding system for a domesticated animal such as a dog or cat comprises a vessel, such as a bowl, where the vessel has an open top end, a closed bottom end, an outer wall upstanding from the bottom end defining substantially the periphery of the vessel, and an inner wall upstanding from the said bottom end forming an inner walled compartment or area, wherein the space between the outer and inner walls defines a channel. The inner walled area and channel form two segmented and separate compartments or stations for feeding and/or hydrating an animal such as a dog or cat.

### FIELD OF THE INVENTION

The present invention relates to a feeding system for an animal. More particularly, the present feeding system comprises a singe-vessel having at least two segmented and separate compartments, for example, one to hold food and one to hold water.

### BACKGROUND OF THE INVENTION

The present invention relates to a system for feeding an animal, more particularly, a domesticated animal like a dog or cat. Using a dog as an example of one domesticated animal, most feeding systems comprise either a single compartment bowl, or a two bowl system resting within a housing. In this latter environment, typically one bowl is used for food, and one is used for hydration, such as water. Some dogs eat dry food, and some eat wet food, yet others are fed a combination of wet and dry food. Some dogs eat all of their food very quickly upon being served, while others nibble at it throughout the day. The water bowl is generally filled at least once a day, or multiple times a day depending upon how thirsty the dog is or how dirty the water gets throughout the day.

There are a number of problems with either setup described above. For example, when feeding a dog, as stated above, some devour their serving in seconds. It is said that this is not good for the animal because it can cause choking problems as well as digestion problems. To overcome this, some prior art feeders use a flatter serving dish or platter, or otherwise include some obstacles or impediments so that the dog will have to “work” at getting to all of the food. Another problem with the present feeding systems is for dogs with longer ears, such as spaniels, hounds and setters. For these breeds, oftentimes when the dogs drink from their water bowl, their ears flop into the water getting them wet, and drippy, which inevitably ends up on the floor of the owner where the bowl is situated. The owner is then compelled to dry the floor for, among other reasons, safety. Given the number of times a dog drinks water in a day, the mopping up an owner has to due is quite burdensome. To address this problem, certain bowls are known which claim to limit the problem by reducing the bowl opening and/or sloping the sides of the bowl. The problem with these types of bowls is that the dog still can approach very nearly the edge of the bowl, drop its head straight down to get the water, and the animal's ears still end up in the bowl—and wet.

Still yet another problem with the prior art for feeding domesticated animals is when more than one bowl is housed within system for a two-bowl set. While this type of system does separate food and water, or wet food and dry food, it does not address the wet-ear problem for long-eared dog breeds, or the devouring food problem, and the footprint for this type of system is approximately double what a one bowl system would use. Thus, there needs to be a means for feeding an animal that comprises a vessel, bowl or the like, that can hold both food and water in separate compartments, while impeding quick consumption of food, keeping ears dry for long-eared dogs breeds, all while reducing the footprint of the feeding system resulting in a more compact and design inspired feeder.

### BRIEF SUMMARY OF THE INVENTION

The current invention presents a feeding system for a domesticated animal such as a dog or cat. The system comprises a vessel, such as a bowl, where the vessel has an open top end, a closed bottom end, an outer wall upstanding from the bottom end defining substantially the periphery of the vessel, and an inner wall upstanding from the said bottom end forming an inner walled compartment or area, wherein the space between the outer and inner walls define a channel. The inner walled area and channel form two segmented and separate compartments for feeding and/or hydrating a dog or cat. However, as it may be understood, it is possible to create more than two segmented compartments if additional walled in areas are incorporated into the feeding system.

Accordingly, it is an object of the present invention to provide a feeding system for an animal comprising a single vessel that is compartmentalized to form more than one eating or drinking area or station.

It is yet another object of the present invention to provide a feeding system that displaces the drinking station away from the periphery of a vessel, and optimally substantially in the center of the vessel, containing liquid hydration such as water, and creating a dry channel adjacent to the vessel's periphery into which the ears of dog breeds having long ears will flop into keeping them away from the hydrating liquid resulting in the animal's ears remaining dry or substantially dry.

It is still yet another object of the present invention to impede an animal from quickly devouring food in a vessel comprised of more than one eating or drinking station by preventing the animal from having unobstructed access to the food compartment by means of the drinking compartment.

It is further an object of the present invention to provide an optional insert into the drinking station of an at least two compartment feeding system vessel to permit a user to replenish or provide clean hydration to an animal without having to remove the vessel itself from its feeding position on the ground, floor or other surface.

It is yet still another object of the present invention to provide an optional restrictive blocking insert into the feeding compartment of a vessel to direct food placed within that compartment to a forward position for access to an animal when, for example, the vessel is situated against or near a wall or other access-impeding location where the animal has limited ability to access to the back or sides of the vessel.

It is still another object of the present invention to provide an impediment to a feeding compartment of a vessel by adding an yet another compartment within the vessel to make food less easily accessible to an animal thus slowing the eating process, resulting in the animal's better health and digestion.

It is also yet another object of the present invention to provide a feeding system for an animal that houses a single vessel which provides sustenance in the form of food, or different kinds of food, and/or water.

It is still yet another object of the present invention to provide a feeding system for an animal that prevents the animal from splashing water or other liquid from a feeding and/or watering vessel onto the floor or other area, and keeps the splashed water within the vessel by means of a substantially centrally located watering compartment.

Other objects and advantages of the present invention will become obvious to the reader and it is intended that these objects and advantages are within the scope of the present invention.

To accomplish the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference numerals designate the same or similar parts throughout the several views, and wherein:

FIG. 1 is a perspective view of the present feeding system for an animal invention;

FIG. 2 is a cross section view of FIG. 1;

FIG. 3 is a perspective view of the present feeding system for an animal invention showing a insert for holding liquid hydration;

FIG. 4 is a cross section view of FIG. 3;

FIG. 5 is a perspective view of the present feeding system for an animal invention showing a channel blocking insert;

FIG. 6 is a cross section view of FIG. 5;

FIG. 7 is a perspective view of the present feeding system for an animal invention shown within a housing; and.

FIG. 8 is a cross section view of FIG. 7.

### DETAILED DESCRIPTION OF THE INVENTION

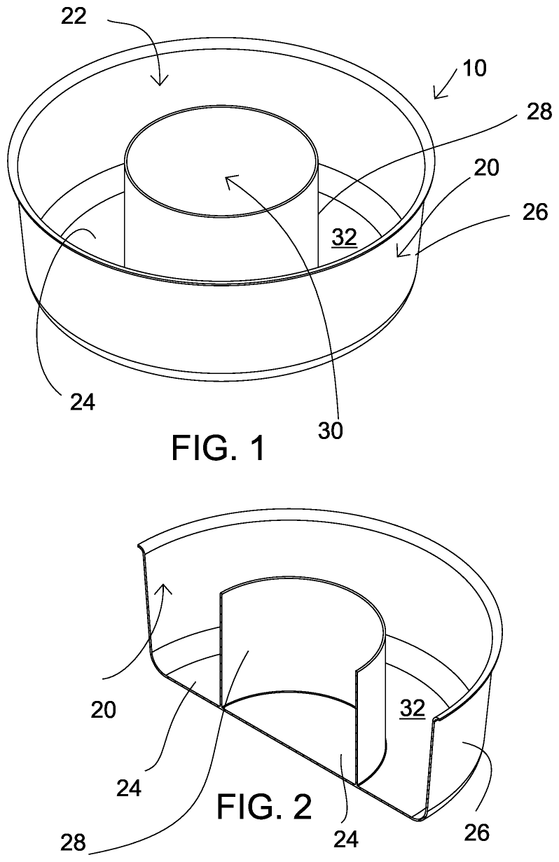

Turning now descriptively to the drawings, in which similar reference numerals denote similar elements throughout the several views, FIGS. 1 through 8 illustrate a feeding system for an animal 10 and pertains principally to domesticated dogs and cats, and more particularly, to dogs. As may be understood from this disclosure however, the feeding system 10 can be adopted and used for all dog and cat breeds.

The feeding system 10 in FIG. 1 comprises a vessel 20. The vessel 20 has an open top end 22, a closed bottom end 24, an outer wall upstanding 26 from the said bottom end 24 defining substantially the periphery of the vessel 20, and an inner wall 28 upstanding from the said bottom end 24 forming an inner walled compartment 30, wherein the space between the outer and inner walls defines a channel 32. The inner walled compartment 30 is preferably substantially centered within the vessel 20. The height of the outer wall 26 and the inner wall 28 can be taller or shorter with respect to one another, depending on the size of the animal to be fed and watered, so long the animal has relatively easy access to the contents of each area.

In a preferred embodiment, the inner walled compartment 30 forms a separate first feeding station from the channel 32 second feeding station and can be used as a hydration reservoir for the animal, such as a water station. Preferably, the channel 32 serves two purposes: to provide an area to hold solid food for the animal, whether wet food, dry food or a combination of the two, and to provide for a distance between the periphery of the vessel 20 and the inner wall 28. The channel 32, intended to hold food and no water, is substantially a dry area such that when an animal, especially one with long droopy ears like a spaniel or hound dog, goes to drink from the inner walled compartment 30, the ears fall into the dry channel and are prevented or impeded from going into the inner walled compartment 30 by the inner wall 28. Thus, the ears remain substantially dry.

Furthermore, the channel 32 formed by the outer wall 26 and inner wall 28 confines the eating area to one that is less than the area of the entire vessel 20. What this does in practice is causes the animal to have to “work” at getting to the food within the channel 32, and thus slows down the eating process as the food is less accessible than it is for a vessel having no inner walled compartment. It has been theorized that slower eating improves the digestion process for the animal and thus, its overall health.

The vessel 20 of FIG. 1 can be made of metal, such as stainless steel, or can be made of plastic. It is, of course, preferable for the vessel 20 to be made of a food grade material. Further, while the dimensions of the vessel 20 are subject to the height of the animal and thus very flexible, the vessel 20 can be manufactured, for example for a medium-sized dog, with approximately a radius of six inches, with the inner walled compartment having an approximate radius of two and a half inches, and the height of both the vessel 20 and inner walled compartment 30 being approximately four inches. It is to be noted that in FIG. 2, the bottom end 24 is continuous throughout the vessel 20.

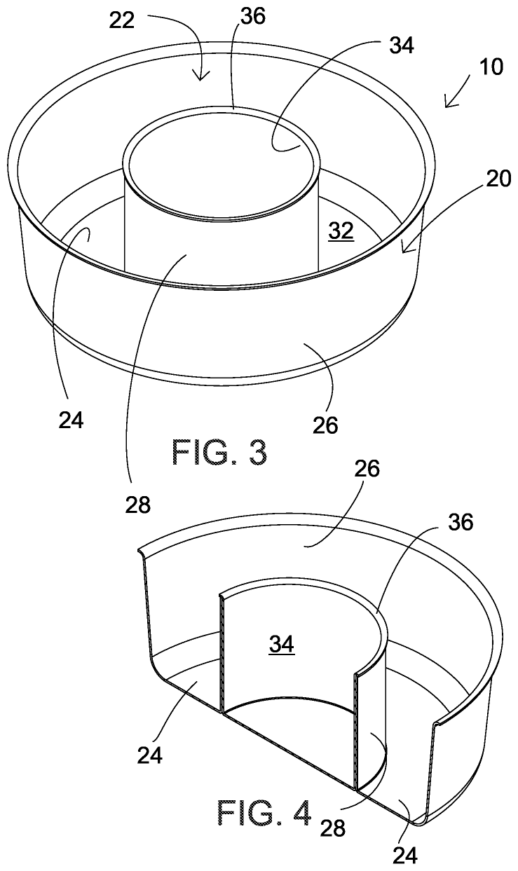

In FIG. 3, the feeding system 10 shows the vessel 20 optionally having a substantially annular shape, with the bottom end 24 forming a component of the channel 32, yet the vessel has no bottom end 24 within the inner walled compartment 30. Rather, a liquid container insert 34 having an open top end, and walls extending upward from a closed bottom end is matably insertable within the inner walled compartment 30. When, for example, the insert 34 which can be filled with water, needs to be refilled or refreshed, it can be removed and filled while leaving the vessel 20 in place. The insert 34 terminates at its open top end in a rim 36 that extends over the inner wall 28 to secure it onto the inner wall 28 and for ease in grasping it to remove and replace it once the insert 34 has been refilled or refreshed. FIG. 4 depicts a cross section of the view of FIG. 3, to show clearly the annular shape of the vessel 20, and that the bottom of the insert 34 is discontinuous with the bottom 24 of the vessel 20. However, as may be understood, there is no reason that the insert 34 cannot rest on a vessel 20 having a continuous bottom 24 has shown in FIGS. 1 and 2. The container insert 34 can, like the vessel 20, be made of metal or plastic, and preferably of a food grade material.

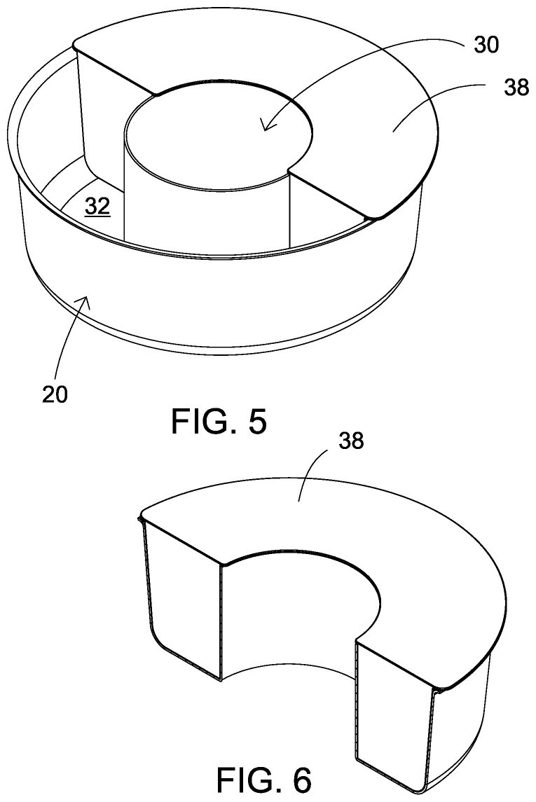

FIG. 5 and FIG. 6 illustrate an optional channel block insert 38 which fits or mates within the channel 32 of vessel 20. The purpose of the channel block 38 is to direct food (not shown) within the channel 32 to a particular location. This is advantageous when the feeding system 10 is placed on the floor or ground, and abuts a rear wall, a side wall or walls, or both. The block 38, being insertable into the channel 32, is slidable within the channel 32 to provide flexibility to the user to direct the location of the food. While it is preferred that the block 38 conforms to the shape of the channel 32, it need not so long as it blocks food from going into an area of the channel 32 to be blocked. The channel block 38 can, like the vessel 20, be made of metal or plastic, and preferably of a food grade material.

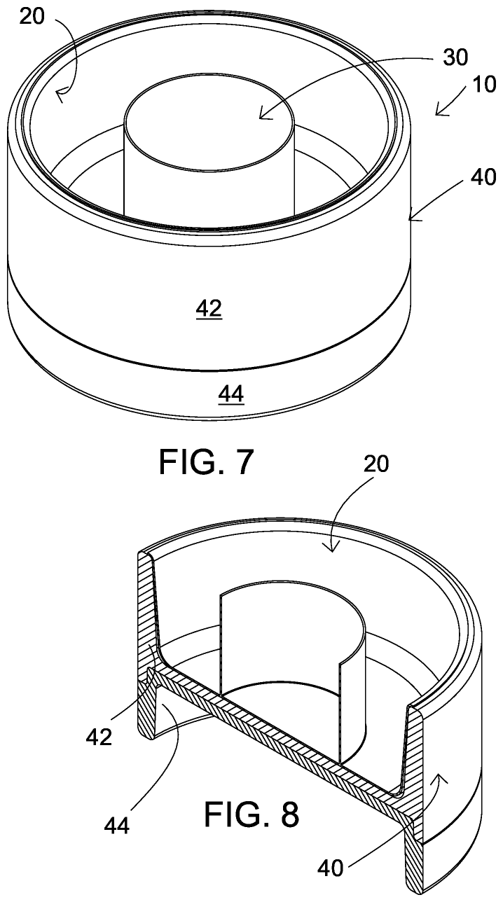

In FIGS. 7 and 8, the vessel 20 of feeding system 10 rests in a housing 40. More particularly, the housing 40 comprises an upper member 42 having a concavity into which the vessel 20 rests. The housing 40 also may comprise a lower member or legs 44. The legs 44 are optional, matably engageable with the upper member 42, and removable therefrom to provide for alternate height to the housing 40, which will be dictated by the height of the animal to feed and water from the feeding system 10. It is contemplated that the housing 40 is manufactured of a plastic or metal.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

What is claimed is:

1. A feeding system for an animal, said feeding system comprising a vessel, wherein said vessel has an open top end, a closed bottom end, an outer wall upstanding from the said bottom end defining substantially the periphery of the said vessel, and an inner wall upstanding from the said bottom end forming an inner walled compartment, wherein the space between the outer and inner walls defines a channel.

2. The feeding system for an animal of claim 1, wherein the said inner walled compartment and channel define separate feeding areas of said vessel.

3. The feeding system for an animal of claim 1, wherein said system further comprises an insert for being substantially matable within the said inner walled compartment.

4. The feeding system for an animal of claim 3, wherein said insert has an open top end, a closed bottom end, and a wall upstanding from the said bottom end forming a removably insertable open-topped container.

5. The feeding system for an animal of claim 4, wherein said vessel comprises an annular shape.

6. The feeding system for an animal of claim 1, wherein said system further comprises a means for restricting the animal's access to food placed within the said channel.

7. The feeding system for an animal of claim 6, wherein said restricting means comprises an channel block to fit within a section of said channel thereby defining a limited area within the channel.

8. A feeding system for an animal, said system comprising a vessel, wherein said vessel has an open top end, a closed bottom end, an outer wall upstanding from the said bottom end defining substantially the periphery of the said vessel, an inner wall upstanding from the said bottom end forming an inner walled compartment, wherein the space between the outer and inner walls defines a channel, and a vessel housing into which said vessel rests forming a single vessel feeding system.

9. The feeding system for an animal of claim 8, wherein said housing further comprises an upper member and a lower legs member to provide height flexibility to said housing to accommodate the height of the animal.

10. The feeding system for an animal of claim 9, wherein said lower legs member is matably attachable with said upper member to raise or lower the said housing.

11. The feeding system for an animal of claim 8, wherein said inner walled compartment is substantially centrally disposed within said vessel.

12. The feeding system for an animal of claim 8, wherein the said inner walled compartment forms a hydration reservoir.

13. A feeding system for an animal, wherein said feeding system comprises a single vessel further comprising at least two feeding stations, wherein said vessel has an open top end, a closed bottom end, an outer wall upstanding from the said bottom end defining substantially the periphery of the said vessel, and an inner wall upstanding from the said bottom end forming a first feeding station inner walled compartment, wherein the space between the outer and inner walls defines a second feeding station channel.

14. The feeding system for an animal of claim 13, wherein said first feeding station comprises a hydration station, and said second feeding station comprises a solid food station.

15. The feeding system for an animal of claim 14, wherein said first feeding station and said second feeding station are separate stations.

16. The feeding system for an animal of claim 15, wherein the said first feeding station is disposed substantially central to the second feeding station.
